(19) United States
(12) Patent Application Publication
(10) Pub. No.: US 2006/0181695 A1
(43) Pub. Date: Aug. 17, 2006

(54) Compensating liquid delivery system and method

(76) Inventor: Burton H. Sage JR., Hot Springs Village, AR (US)

Correspondence Address: BURTON H. SAGE, JR., 2453 IMPALA DRIVE, CARLSBAD, CA, 92008, US

(21) Appl. No.: 11/055,643

(22) Filed: Feb. 11, 2005

(51) Int. Cl. G01P 3/36

(52) U.S. Cl. 356/28.5

(57) ABSTRACT

A compensating fluid supply system that is capable of near real time adjustment of the timing of a pumping action of a positive displacement pump is disclosed. The geometrical characteristics of a flow tube and a velocity of a moving stream are used to measure individual pumping actions. Based on the actual measured volume of fluid supplied with a pumping action and the desired supply rate of the fluid supply system, the timing of future pumping actions is determined.

This application claims subject matter disclosed in co-pending application Ser. No. 10/662,871 filed Oct. 13, 2003. The content of this document is incorporated herein in its entirety by reference.

### FIELD OF THE INVENTION

This invention relates generally to fluid delivery systems and more particularly to liquid supply systems for use in drug delivery.

### BACKGROUND OF THE INVENTION

Accurate delivery of liquids, particularly in the field of infusion of medical liquids continues to be an important need. See, for example, Simmons, et al “An Adaptive Drug Infusion System”, Diabetes Technology and Therapeutics 6:5 p 607-20 (November, 2004), the content of which is incorporated herein in its entirety by reference. In IV infusion of pharmaceuticals, accurate infusion of therapeutic solutions is becoming more and more critical as the potency of infusible therapeutic agents continues to increase and the volumes of fluids decrease. This need is especially critical in neonatal and pediatric infusion.

Historically, IV infusions were performed with the active ingredient dissolved in an appropriate vehicle hanging in a bag from a pole above the patient. Such gravity bag infusion, while able to provide the medical liquid to the patient in a continuous fashion, suffered from accuracy problems. Because the driving force is derived from the height of the solution above the infusion site, the driving force would change with any change in this height, such as when the bag empties of solution, when the patient moves from a prone position to lying on a side, and especially when the patient arose from bed.

The rate of infusion would also change with temperature due to changes in the viscosity of the medical liquid, and could drastically change when different medical liquids of different viscosity were used. Further, the rate of infusion would change significantly when different infusion sets were used due to the manufacturing tolerances of the inside diameter of the flow tube. While the user of a gravity bag infusion set could adjust the infusion rate using a roller clamp on the tube and counting the drips per second in a drip chamber included in the infusion set, the accuracy of such an adjustment was qualitative at best.

To overcome these limitations, positive displacement infusion pumps have replaced gravity bags for the intravenous delivery of medical liquids, especially for those liquids where precise control of the delivery rate is important. These positive displacement pumps include syringe pumps, where the volume of fluid to be infused is relatively small, and peristaltic pumps, where the volume of the medical liquid to be infused is relatively large. Positive displacement pumps are designed in such a way that a fixed volume of liquid is delivered independent of the pressure required to deliver the liquid or the viscosity of the delivered liquid. With these two variables removed, infusion pumps overcame two of the major obstacles to accurate delivery which are inherent in gravity bag infusion systems.

Today's positive displacement medical liquid infusion systems are “open-loop” systems in that they rely on the dimensional accuracy of system components to achieve accurate delivery. For syringe pumps, for example, the accuracy of delivery is mainly dependent on the inside diameter of the barrel of the syringe in use. Since the accuracy depends on the square of the inside diameter, it is important to manufacture these syringes with close tolerances. For peristaltic pumps, the accuracy of delivery depends on the inside diameter of the flow tube at the site where the peristaltic pumping occurs. Again, the delivery accuracy depends on the inside diameter of the flow tube to the second power, so manufacturing tolerances are relatively tight. Further, with peristaltic pumps during use, as the flow tube is repeatable compressed to move the fluid along the tube, the dimensions of the tube change causing the quantity of fluid moved each pump cycle to slowly change over time. Also, if system components are used that are outside of the specification range, such positive displacement systems will inaccurately deliver the medical liquid. Since these systems are “open-loop”, these changes are not recognized and the pump continues to deliver fluid at an improper rate.

In an attempt to address this problem, closed loop medical liquid infusion systems have been described (see, e.g., Frank U.S. Pat. No. 5,211,626). This system measures the flow rate of the medical liquid along the flow channel and then adjusts the position of a proportional valve to achieve the desired flow rate. This closed loop system, however, fails to distinguish between changes in flow rate due to temperature, viscosity, or flow channel dimensions. Because the flow rate has differing exponential dependence for these flow rate variables, the calculated valve adjustment does not completely correct the flow rate discrepancy, resulting in incompletely corrected infusion of the medical liquid.

Another approach to compensate for system variables to achieve accurate supply of liquid therapeutic agents is described in Sage U.S. Pat. No. 6,582,393. However, this system is limited to pressurized fluid supply reservoirs, and does not describe the methods appropriate for compensating for the variability in system components that arise either from manufacture or use in positive displacement fluid delivery system.

While representing a significant improvement over simple and inexpensive gravity bags, complicated and expensive infusion pumps still typically fail to achieve highly accurate delivery over the course of desired infusion, or to provide evidence that the desired drug delivery is occurring or has occurred (other than that the motor is operating or has operated). The actual flow rate remains unverified.

### SUMMARY OF THE INVENTION

In accordance with one embodiment, a device for delivering liquid via a flow channel is disclosed. The device includes a memory having a stored value indicative of a flow characteristic of the flow channel coupled to the flow channel, a flow sensor that measures at least one characteristic of the flow of the liquid through the channel, a pump capable of delivering liquid to the channel in strokes having a nominal volume, a pump driver capable of causing the pump to deliver the liquid on a stroke by stroke basis, an interface by which a user of the device may enter information such that a desired rate of delivery of the liquid is enabled, and a processor adapted to calculate an actual liquid flow rate from the stored value and the sensor output, to compare the calculated flow rate to the desired flow rate, and to calculate the timing of at least one future pump stroke such that the actual flow rate more closely approximates the desired flow rate.

The pump may be a peristaltic pump, a syringe pump, a piston pump, or any other pump whereby a nominal volume of liquid is dispensed to a liquid supply line by a single action of the pump and whereby repeated actions of the pump dispense similar nominal volumes of fluid for each pumping action. The sensor may an optical flow sensor, as is described in co-pending application Ser. No. 05/146,588, or may be any other thermal time of flight sensor where heat is applied to an incremental volume of fluid and the flow of the fluid carries that incremental heated fluid volume past an interrogation region where the passage of the heated incremental fluid volume is detected. Preferably, the flow sensor is one where the measurement of the fluid flow is made in a non-contact fashion, that is, the components of the sensor are physically isolated from the fluid flow.

In accordance with another aspect of the invention, a two component system for delivering liquid via a flow channel is disclosed. The system comprises a first component comprising a flow channel and a memory for storing a flow related characteristic of the channel coupled to the channel. The first component may be part of a disposable infusion set for dispensing therapeutic solutions to patients via the intravenous or subcutaneous or arterial routes of administration. The system further comprises a second component which mates with the first component. The second component comprises a reader capable of reading the flow related information contained in the memory of the first component, a flow sensor capable of measuring at least one flow related property of the liquid flowing in the flow channel, a fluid delivery component and fluid delivery component driver capable of delivering the fluid to the flow channel in discrete strokes of a nominal volume, and a processor for using the flow channel related information in the first component and the flow related information from the flow sensor to adjust the timing the discrete strokes of the fluid delivery component.

As above, the fluid delivery component may be peristaltic pump, a syringe pump, a piston pump, or any of a number of pumping devices that dispense liquid in essentially discrete strokes with each essentially discrete stroke having essentially the same nominal stroke volume. The sensor may an optical flow sensor, as is described in co-pending application Ser. No. 05/146,588, or may be any other thermal time of flight sensor where heat is applied to an incremental volume of fluid and the flow of the fluid carries that incremental heated fluid volume past an interrogation region where the passage of the heated incremental fluid volume is detected. Preferably, the flow sensor is one where the measurement of the fluid flow is made in a non-contact fashion, that is, the components of the sensor are physically isolated from the fluid flow.

The memory may be a solid state memory device such as is common in the computer industry today, or it may be magnetic or electrostatic or optical such as a bar code, or it may be mechanical such as an array of raised or depressed areas on an otherwise planar surface. The memory may be of any form with the only limitation that the memory is able to be read by the second component when the first component and the second component are mated.

In accordance with yet another embodiment, a method is disclosed for delivering a liquid via a flow channel at a desired flow rate. Flow-related data of the liquid in the flow channel is measured, and a memory is accessed for a flow characteristic of the flow channel stored therein. A value of the flow rate of the liquid is calculated based on the flow-related data and the stored characteristic value, and the calculated value of the flow rate is compared to the desired flow rate. The timing of a stroke of a positive displacement pump is calculated based on the difference between the desired and calculated flow rates.

In accordance with a further embodiment of the invention, a disposable fluid supply conduit is disclosed. The fluid supply conduit comprises a flow cell, the flow cell further comprising an inlet, an outlet, an interrogation region, and registration points for proper mating of the disposable fluid supply conduit to a sensor capable of making a measurement of fluid flow in the interrogation region. The flow cell also comprises a memory containing information related to a geometrical property of the flow cell. Alternatively, the fluid supply conduit comprises the memory physically separated from the flow cell but coupled to the conduit such during mating of the flow cell to the sensor a reader coupled to the flow cell may read the memory. In this case the flow cell comprises an inlet, an outlet, an interrogation region, and registration points for proper mating of the flow cell to the sensor.

In accordance with another embodiment, a device for delivering liquid via a flow channel is disclosed. The device includes a memory having a stored value indicative of a flow characteristic of the flow channel coupled to the flow channel, a flow sensor that measures at least one characteristic of the flow of the liquid through the channel, a pump capable of delivering liquid to the channel in strokes having a nominal volume, a pump driver capable of causing the pump to deliver the liquid on a stroke by stroke basis wherein the volume of the stroke is variable, an interface by which a user of the device may enter information such that a desired rate of delivery of the liquid is enabled, and a processor adapted to calculate an actual liquid flow rate from the stored value and the sensor output, to compare the calculated flow rate to the desired flow rate, and to calculate the volume of at least one future pump stroke such that the actual flow rate more closely approximates the desired flow rate. Alternatively, the device of this embodiment may alter both the volume of pump strokes and the time interval between strokes to achieve the desired fluid supply rate.

The pump may be a syringe pump, a piston pump such as a piezoelectric pump or shape memory alloy pump, or any other pump wherein the volume of liquid dispensed to a liquid supply line by a single action of the pump is variable and adjustable such that the pump driver may cause the pump to make strokes of differing volumes by altering a drive variable such as drive voltage or drive current. The sensor may be an optical flow sensor, as is described in co-pending application Ser. No. 05/146,588, or may be any other thermal time of flight sensor where heat is applied to an incremental volume of fluid and the flow of the fluid carries that incremental heated fluid volume past an interrogation region where the passage of the heated incremental fluid volume is detected. Preferably, the flow sensor is one where the measurement of the fluid flow is made in a non-contact fashion, that is, the components of the sensor are physically isolated from the fluid flow.

In accordance with a still further embodiment of the invention, a method of manufacture of a fluid supply conduit is disclosed. The fluid supply conduit comprises a flow cell which further comprises a fluid inlet, a fluid outlet, an interrogation region, and a memory. During manufacture, the flow cell is placed in a fixture and a known fluid is caused to flow through the flow cell under known conditions. A sensor is positioned to measure a property of the flow of the known fluid. This property of flow is used to calculate a geometrical property of the flow cell and the geometrical property is stored in the memory. As above, the memory may be of any form, the only limitation being that it is readable by a reader at time of use.

In operation of the first embodiment, a user provides a volume of fluid to be supplied for the system. The user also connects the output of the system to the point to which the fluid is to be supplied. In use for intravenous delivery of therapeutic solutions, an IV bag may be supplied with the volume of solution, and the vein of a patient is the point where the solution is to be supplied. The user primes the infusion line and then selects a fluid supply rate using an interface to the system and starts the system. The system begins by instructing the pump driver to supply fluid with at least one pump actuation or stroke. During the pump actuation, the sensor reads one or more properties of fluid flow at least once but usually many times during a single pump actuation. The properties may include the velocity of the fluid stream, and, using the stored characteristic, calculates the actual volume of fluid that flowed during the pump stroke. Using this volume and the current pump stroke rate, such as strokes per hour, the system may calculate the actual flow rate of the pump at the current time. It may then compare this actual flow rate to the desired flow rate. If the actual and desired flow rates are equal, or within an acceptable range, the system may leave the stroke rate as it is until the next stroke occurs, when the system will again measure the volume of fluid delivered by the stroke. If the actual and desired flow rate are not sufficiently close, the system may calculate a new time for the next stroke to occur. This new time may be longer than the current interval between strokes if the actual flow rate is higher than the desired flow rate, or may be shorter than the current interval between strokes if the actual flow rate is lower than the desired flow rate.

In the use of a second embodiment of the invention where the system is comprised of two components—a disposable infusion set which connects with the reservoir of fluid to be administered and with a cannula typically in a vein for administering the fluid to the patient, and a reusable component which typically comprises the sensor for measuring the flow through the infusion set, a reader for reading the flow cell geometry information, a fluid driver, an interface through which the operation of the system is managed, and a processor for converting operational instructions from the interface and sensor information into instructions for the fluid driver such that the desired delivery protocol is realized.

The infusion set is coupled to the reusable component such that fluid in the flow path may be observed by the flow sensor in the reusable component and the memory containing information related to the flow path may be read by the reader. The inlet end of the infusion set is connected to the fluid supply. The system is then primed such that the infusion set is filled with the fluid and flow is stopped. Then the cannula at the outlet end is placed in the vein. The desired flow protocol for administering the fluid to the patient is entered through the interface and the protocol is implemented. The processor causes the pump driver to begin delivery of the fluid through the infusion set by taking at least one pumping action. During the pumping action, the flow sensor records at least one property of flow at least once, but typically many times. Typically, the flow sensor measures a velocity of the fluid, but may alternatively measure volumetric flow rate. The flow sensor makes sufficient measurements of the flow such that the volume of fluid delivered by the pumping action is accurately measured. Depending on the rate of change of flow rate, the sensor may be capable of measuring flow rate up to several thousand times per second. The processor then combines the measured delivered fluid volume and the current rate of pumping actions to calculate the current actual fluid delivery rate. This actual fluid delivery rate is then compared to the desired fluid delivery rate, and the timing of the next pump driver action is adjusted such that if the measured fluid delivery rate is higher than the desired fluid delivery rate, the time until the next pump action is lengthened and if the measured fluid delivery rate is lower than the desired fluid delivery rate, the time until the next pump driver action is shortened.

In summary, the invention is the measurement of the volume of fluid delivered by individual pumping actions of a pump and the adjusting of the timing of subsequent pumping actions or the volume of subsequent pumping actions, or both, such that the calculated actual fluid delivery rate more nearly matches the desired fluid delivery rate.

### SHORT DESCRIPTION OF THE FIGURES

FIG. 1 shows a schematic of the embodiment shown in FIG. 3 with the pump about to start a delivery action.

FIG. 2 shows a schematic of one embodiment of the fluid supply system including a pump driver and a pump having completed one delivery action.

FIG. 3 is a schematic of the fluid supply device with a piezoelectric actuator in the fill position.

FIG. 4 is a schematic of the fluid supply device with a piezoelectric actuator in the fluid eject position.

FIG. 5 shows a pictorial view of the two component embodiment of the invention comprising a disposable infusion set coupled to a reusable programmable fluid delivery system.

FIG. 6 shows a schematic of the flow cell and memory of the disposable infusion set.

FIG. 7 portrays the fluid flow as a function of time showing discrete pumping actions and the flow during one such pumping action. FIG. 7 further shows the times at which the sensor measures a property of fluid flow.

FIG. 8 is a manufacturing schematic for measuring flow properties of a flow tube.

### DETAILED DESCRIPTION OF EMBODIMENTS

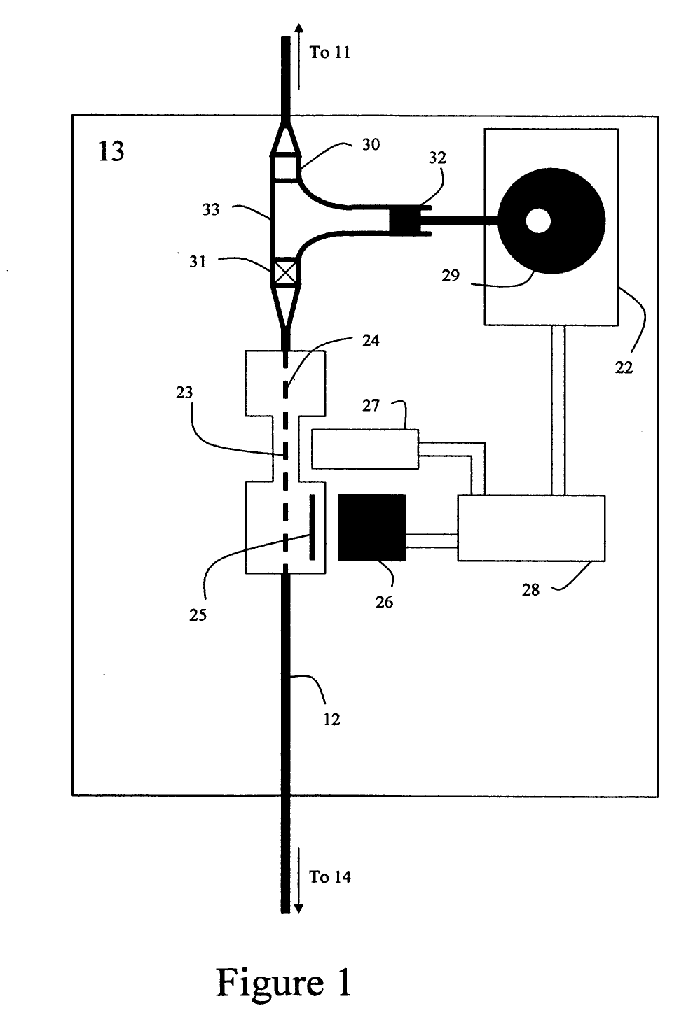

A first embodiment of the invention shows fluid supply system 13 in FIG. 1. Fluid enters flow path 12 from fluid supply container 11 (not shown). The fluid from supply container 11 enters the system 13 through valve 30 of pump 33. As shown, pump 33 has drawn fluid into its body through valve 30 since valve 30 is open. Since valve 31 is closed, this fluid remains in the pump awaiting the next pumping action. Pump 33 is under the control of pump driver 22 which is designed to rotate cam 29 to move piston 32. Processor 28 provides pumping instructions to driver 22. Also providing input to processor 28 is sensor 27, which measures at least one property of fluid flow along flow path 24 in interrogation region 23, and reader 26, which reads at least one property of interrogation region 23 stored in memory 25. The property of flow measured by sensor 27 is for example stream velocity as expressed in distance per time. Flow sensor 27 may operate by a number of different mechanisms such as thermal time of flight, where heat is injected into the fluid at one point in the interrogation region and the heated fluid is detected at a downstream location in the interrogation region. The heaters and detectors may be in contact with the fluid or they may be isolated from the fluid. Alternatively, vanes or other similar operators may be inserted into the stream to measure stream velocity.

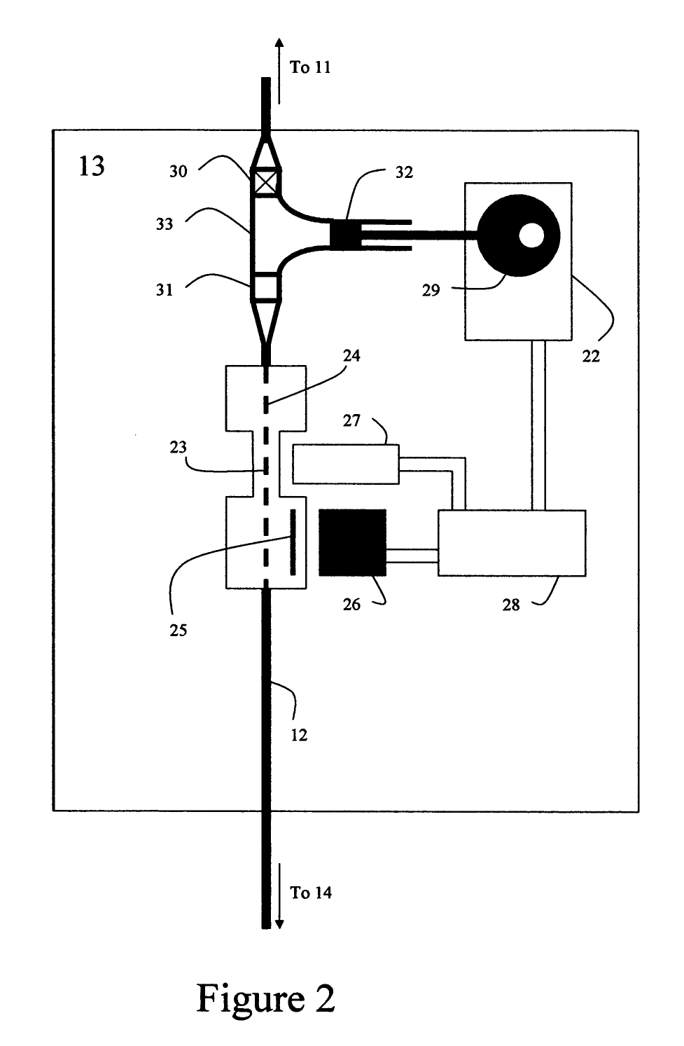

At a point in time selected by processor 28, processor 28 instructs pump driver 22 to cause pump 30 to perform a pumping action. Valve 30 closes, valve 31 opens, and cam 29 rotates 180 degrees to the position shown in FIG. 2. This pumping action forces fluid along flow paths 24 and 12 as well as through interrogation region 23. To complete the pumping cycle, cycle, valve 31 closes and valve 32 opens, so that when pump driver 22 causes cam 29 to complete its rotation, pump 33 completes a pumping action and returns to the condition shown in FIG. 1.

FIGS. 1 and 2 are exemplary embodiments only. Pump 33 could be a syringe pump where driver 22 and cam 29 are replaced by a lead screw and a stepper motor as is well known in the art.

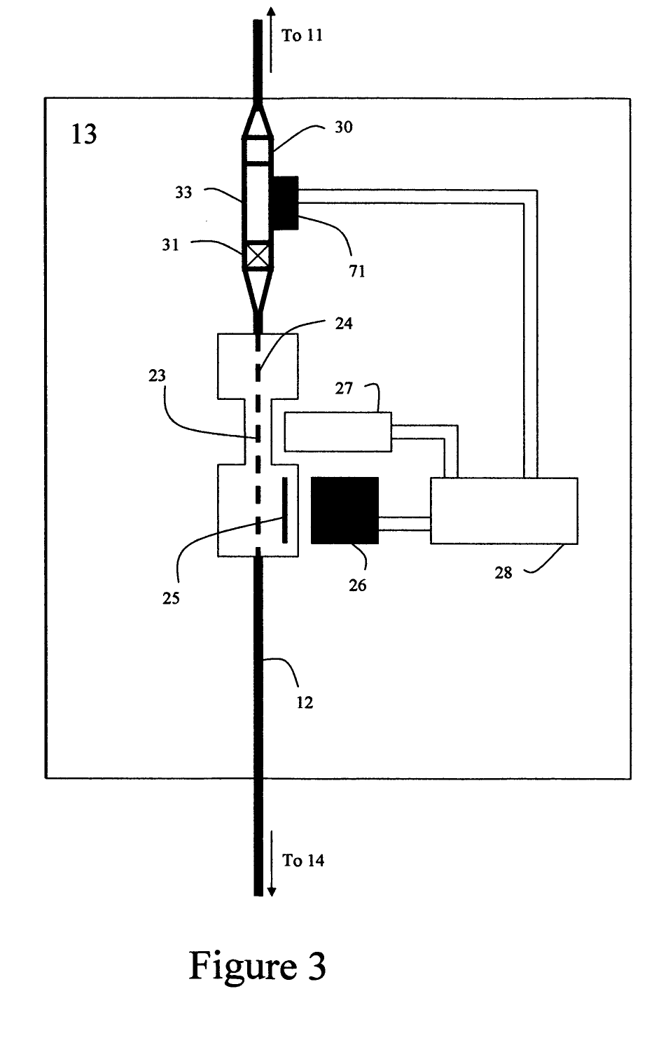

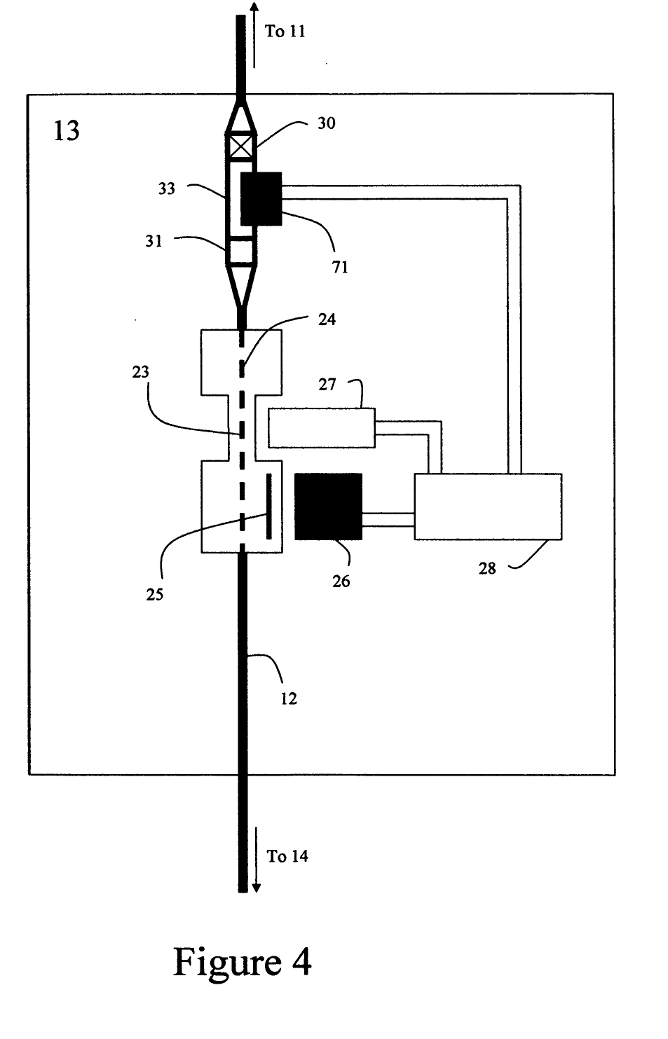

Pump 33 could be also be a peizoelectrically actuated pump or a shape memory alloy actuated pump where the cam action is replaced by the motion of the piezoelectric or shape memory alloy device as is shown in FIGS. 3 and 4. In FIG. 3, piezoelectric element 71 is shown in the relaxed state. With valve 30 open and valve 31 closed, the relaxation of piezoelectric element 71 will draw fluid from source 11 into the body of pump 33. At a selected time, processor 28 will activate piezoelectric element 71 to the state shown schematically in FIG. 4. With valve 30 now closed and valve 31 now open, the action of piezoelectric element 71 will pump fluid through the system. The volume of fluid supplied by the piezoelectric pump in a given stroke is determined by the electrical inputs provided by processor and pump driver 28 shown in FIGS. 3 and 4. The amount of deflection of a piezoelectric element is determined by the voltage impressed on the element. The greater the voltage, the greater the deflection of the element, and the greater the volume of fluid delivered by a single stroke of the pump.

The significant difference between the piston pump shown in FIGS. 1 and 2 and the piezoelectric pump shown in FIGS. 3 and 4 is that the piston pump has a fixed stroke while the piezoelectric or shape memory alloy pump has a variable stroke depending on the electrical inputs provided by processor and driver 28. To change the supply rate for the piston pump, the only variable is the frequency of pump strokes—the greater the number of strokes per unit time, the higher the fluid supply rate. To change the supply rate for the piezoelectric or shape memory alloy pump, both the frequency of strokes and the volume of each individual stroke may be altered.

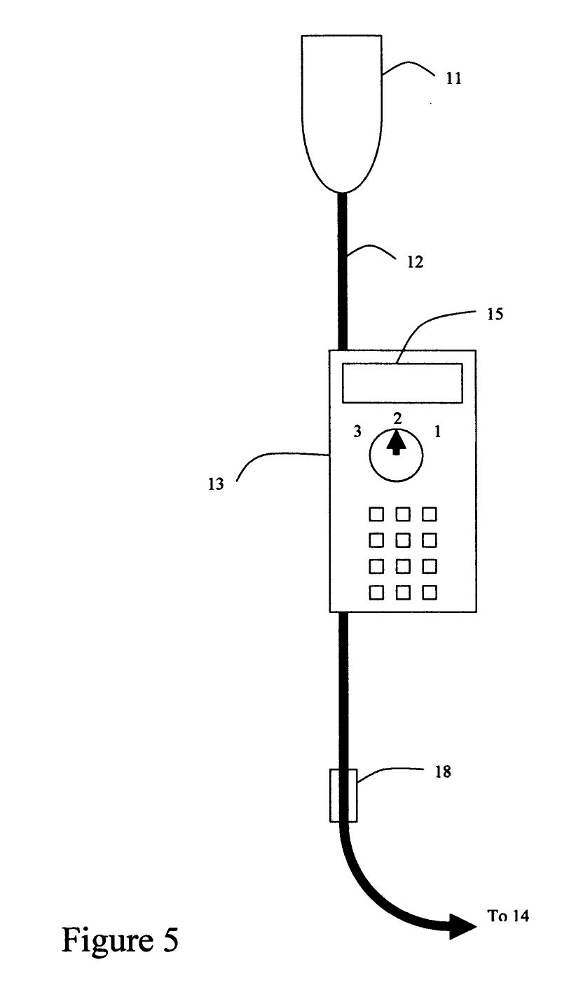

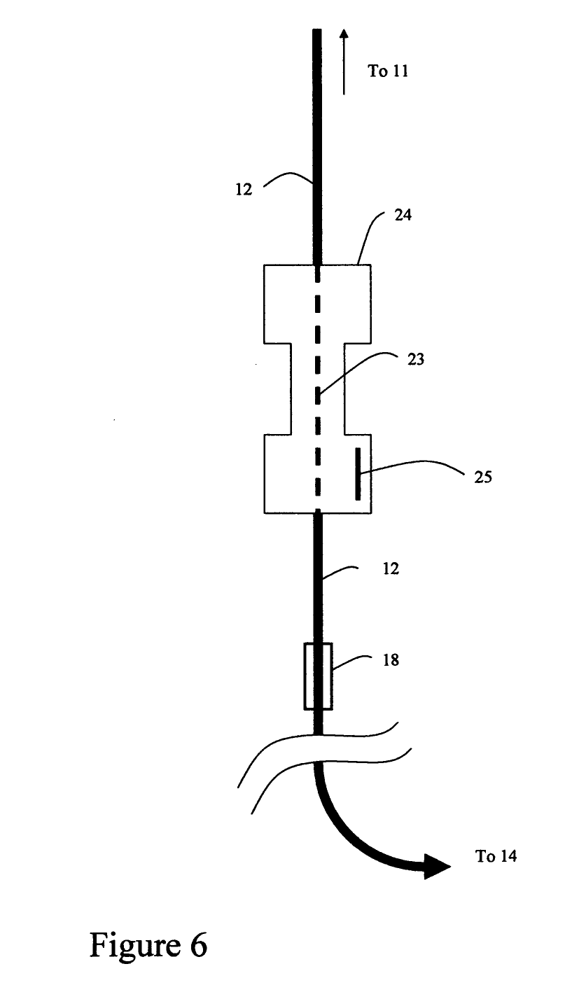

As shown in FIGS. 1, 2, 3, and 4, the fluid delivery system of this invention is a single integrated system. The fluid delivery system of this invention may also be configured as a reusable fluid flow control unit and a disposable infusion set as shown in FIGS. 5 and 6. FIG. 6 shows the disposable infusion set 12 comprising flow channel 24, interrogation region 23, and memory 25. As in other embodiments, memory 25 contains information regarding the geometry of flow channel 24. Disposable infusion set 12 mates with reusable fluid flow control unit 13 as shown in FIG. 5. As mated, the system is operationally similar to that shown in FIGS. 1, 2, 3, and 4 with the main exception that the pump is not integral to the flow path as shown in FIGS. 1, 2, 3, and 4 but operates on disposable infusion set 12 to cause fluid to progress down the infusion set. An example of such a non-integral pumping mechanism is a peristaltic pump which is well known in the art. Alternatively disposable infusion set 12 may comprise a disposable pump mechanism (not shown) such that the pump actuator which causes the disposable pump mechanism to supply fluid is part of reusable fluid flow control unit 13. Such two-part pumping mechanisms, for example a peristaltic pump unit where the rollers are part of the infusion set and the motor that causes the rollers to rotate is part of the control unit, are well known in the art.

In use, disposable infusion set 12 in FIG. 6 is connected to fluid supply container 11 and fluid from supply container 11 is caused to flow, usually by gravity, to prime the system by opening roller clamp 18. Once primed, if the system is to be used for intravenous delivery of a therapeutic agent, cannula 14 (not shown) is placed in the vein of the patient. Disposable infusion set 12 is then mated to fluid flow controller 13 as shown in FIG. 5. Fluid flow controller detects the mating of disposable infusion set 12 using memory reader 26 as shown in FIGS. 1, 2, 3, and 4. Memory reader 26 also reads the geometrical information stored in memory 25. Processor 28 receives the mating and geometrical information and displays a “ready” indication through display unit 15 shown in FIG. 5. The user now enters desired fluid administration instructions through the keyboard on fluid control unit 13. These fluid administration instructions are stored in processor 28 as shown in FIGS. 1, 2, 3, and 4. Roller clamp 18 is now opened and fluid administration is begun.

To begin fluid administration, processor 28 instructs pump driver 22 to cause pump 33 to make a pumping action as shown in FIGS. 1, 2, 3, and 4. Processor 28 also instructs sensor 27 to begin making measurements of at least one flow property of the fluid flow in interrogation region 23. Sensor 27 continues to make flow measurements throughout the pumping action initiated by processor 28, and may continue to take flow measurements after the pumping action is complete. Flow measurements after completion of the pumping action are especially important if the pump is not perfect, that is, if there is a small amount of residual flow either forward or retrograde between pumping actions since the goal of any fluid delivery system is to measure the total amount of fluid delivered, not just the amount of fluid delivered during a pumping action.

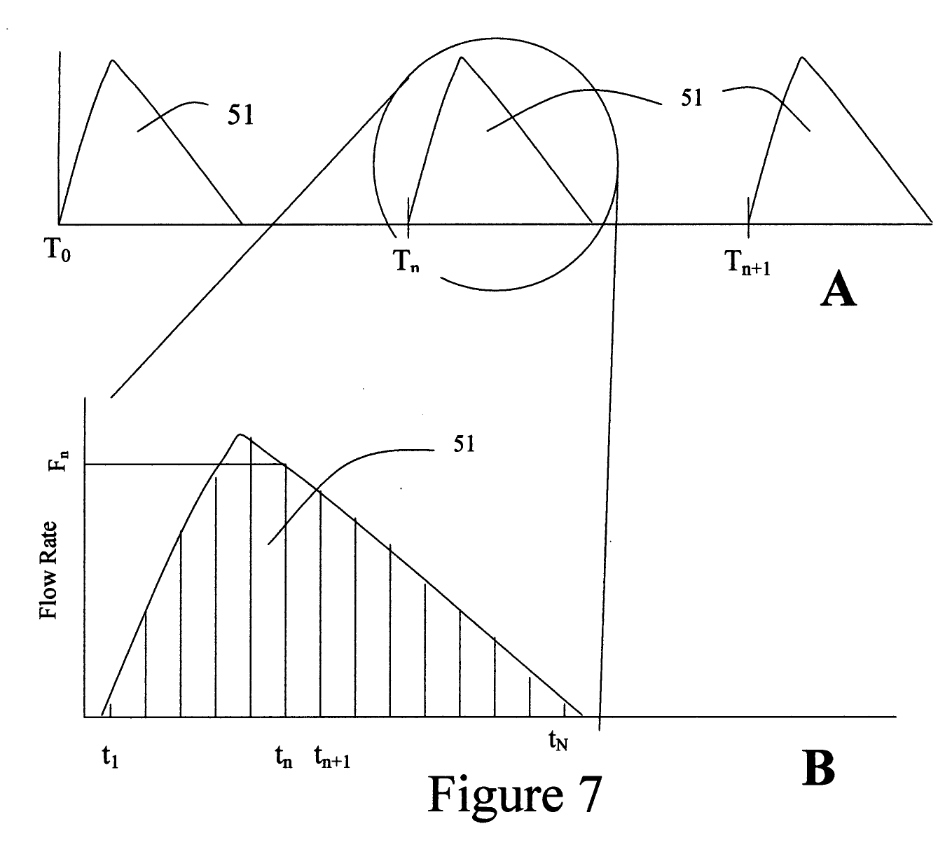

Sensor 27 also provides the measured flow properties, during a pumping action and at times between pumping actions, to processor 28. FIG. 7 shows one example of flow profiles during a sequence of pumping actions that may be measured by flow sensor 27. Shown in the upper portion of FIG. 7 is a sequence of three fluid flow profiles. These profiles, for example, could be measured stream velocity as a function of time, but could be other measurements of the flowing stream such as the rotation rate of a propeller in the stream or the bending angle of a vane in the stream, or could be the volumetric or mass flow rate. These flow profiles are the result of pumping actions taken by pump 33. The pumping actions are taken at time T₀, Tₙ, and Tₙ₊₁ such that there may be an apparent fixed periodicity of the pumping actions, but in fact the actual timing of pumping actions is dictated by measurements of delivered volumes and comparisons to desired delivery rates such that the measured delivered volume equals the desired delivery volume. The result is a more accurate delivery of liquid than could be achieved by setting a fixed periodicity of pumping actions assuming typical performance parameters of pumping components.

Shown in the lower portion of FIG. 7 is an example of the timing of measurements of flow properties made by sensor 27 of the flow pulse 51. Time t₁ may be simultaneous with time T₀ but may also be slightly after T₀. Time tₙ represents any one of the sampling times. The number of samples taken, n, may be any number but in general, the larger the sample number, the more accurate the result.

The volume of fluid delivered during flow rate pulse 51 may be determined by calculating the area under the curve (AUC) of flow pulse 51. There are many ways of calculating the AUC of flow pulse 51, a typical way being as follows:

$$AUC = \frac{1}{2} {\sum }_{n = 1}^{n = N} ( {F}_{n + 1} + {F}_{n} ) ( {t}_{n + 1} - {t}_{n} )$$

where Fₙ is the flow rate at tₙ.

Having calculated the volume of fluid delivered by one pumping action, the actual fluid delivery rate can be determined by multiplying the delivered volume by the pumping rate. This calculated fluid delivery rate may be compared to the desired fluid delivery rate to determine if the delivery rate is too high, too low, or at the desired fluid delivery rate. If the delivery rate is too high, the next pumping action can be delayed slightly. If the delivery rate is too low, the next pumping action can be made to occur earlier than planned. If the delivery rate is at the desired rate, the next pumping action can be executed as planned. Alternatively, for pumps having a variable stroke volume, the electrical inputs which dictate the stroke volume may be adjusted such that a new stroke volume is selected where the product of the new volume per stroke and stroke rate are set equal to the desired supply rate. Also, for these pumps with a variable stroke volume, both a new stroke volume and a new stroke rate may be adjusted such that the product of the stroke volume and the stroke rate is equal to the desired supply rate.

The calculations made by processor 28 are made in the context of the following theory. For fluids in laminar flow in a channel with a circular cross section, the volumetric flow rate Q is given by the Poiseuille's equation:

$$Q = \frac{π P {A}^{2}}{8 η L} \qquad ( 1 )$$

Where
Q=flow rate in volume per time
P=Pressure
A=flow channel effective cross sectional area
η=fluid viscosity
L=flow channel length

Flow rate Q is also given by AV where again A is the effective cross sectional area of the circular flow tube and V is the average velocity of flow of the fluid down the channel. Please note the use of the words effective and average. This usage is due to the fact that no flow channel is perfectly round or has exactly the same cross sectional area at all points along the flow channel. Further, it is well known that for laminar flow in the channel, the velocity profile is parabolic with the maximum stream velocity along the axis or center of the channel. Because of this variation in cross sectional area, the average velocity of the liquid will not be exactly the same at all points along the channel. Note further that A can be expressed in terms of an effective radius R such that A=πR² or in terms of an effective diameter D such that A=πD²/4.

The velocity of flow in a channel can be measured by the well known “Thermal Time of Flight” method, but other methods of measuring a velocity of the flow stream may be used. The “thermal time of flight” method is described in detail in many texts but also described in U.S. Pat. No. 6,582,393, incorporated herein by reference in its entirety. In general, the fluid is heated at one point along the channel, and the heated fluid is detected downstream by a heat sensor. The velocity is calculated by measuring the distance downstream from the point of heating to the point of detection and dividing that distance by the elapsed time between heating the fluid and detecting the heated fluid. Letting X equal the separation distance between the point of heating and the point of detection, and T equal the measured time of flight, the flow rate Q=AX/T.

In a drug delivery system where a reusable flow sensor is mated with a flow channel on a disposable infusion set, the flow sensor will be used with a number of unknown flow channels. Given routine manufacturing tolerances of flow channels, their cross sectional area may vary as much as 25%. Thus the flow rate Q as calculated from the time of flight T and the separation distance X is dependent on the cross-sectional area and will also have an inherent error of as much as 25%.

To address this problem, the following method may be used. In the laboratory, a nominal or standard flow system that is identical to the planned marketed system except for manufacturing tolerances of the flow tube cross section area is set up. Using the standard AAMI (Association for the Advancement of Medical Instrumentation) protocol, the flow rate through this standard system is measured by weighing the amount of a standard fluid that has been delivered for a fixed period of time. The temperature of the liquid (to establish its viscosity), and the driving pressure are also set at nominal or standard values. A reference flow tube is also selected to be a standard.

Letting the subscript ₀ denote the nominal, standard or predetermined flow condition, Poiseuille's equation for the nominal or standard setup is given by:

$${Q}_{0} = \frac{π {P}_{0} {A}_{0}^{2}}{8 {η}_{0} L} \qquad ( 2 )$$

For a randomly selected flow channel measured under these conditions, wherein the subscript 1 is used to denote a randomly selected flow channel, the flow rate is:

$${Q}_{1} = \frac{π {P}_{0} {A}_{1}^{2}}{8 {η}_{0} L} \qquad ( 3 )$$

By dividing these two equations, the following useful result is obtained:
Q₁/Q₀=A₁²/A₀² (4)

And, using the relationship Q=AX/T, which can be used since pressure and viscosity have been set at standard conditions, it can be shown that
T₀/T₁=A₁/A₀ (5)

Thus the flow rate for the randomly selected tube can be determined as
Q₁=Q₀T₀²/T₁² (6)

The above equation gives the flow rate in the randomly selected tube in terms of the flow rate in the nominal or standard tube, the measured time of flight in the standard tube, and the measured time of flight in the randomly selected tube given the nominal or standard pressure and the nominal liquid at nominal temperature.

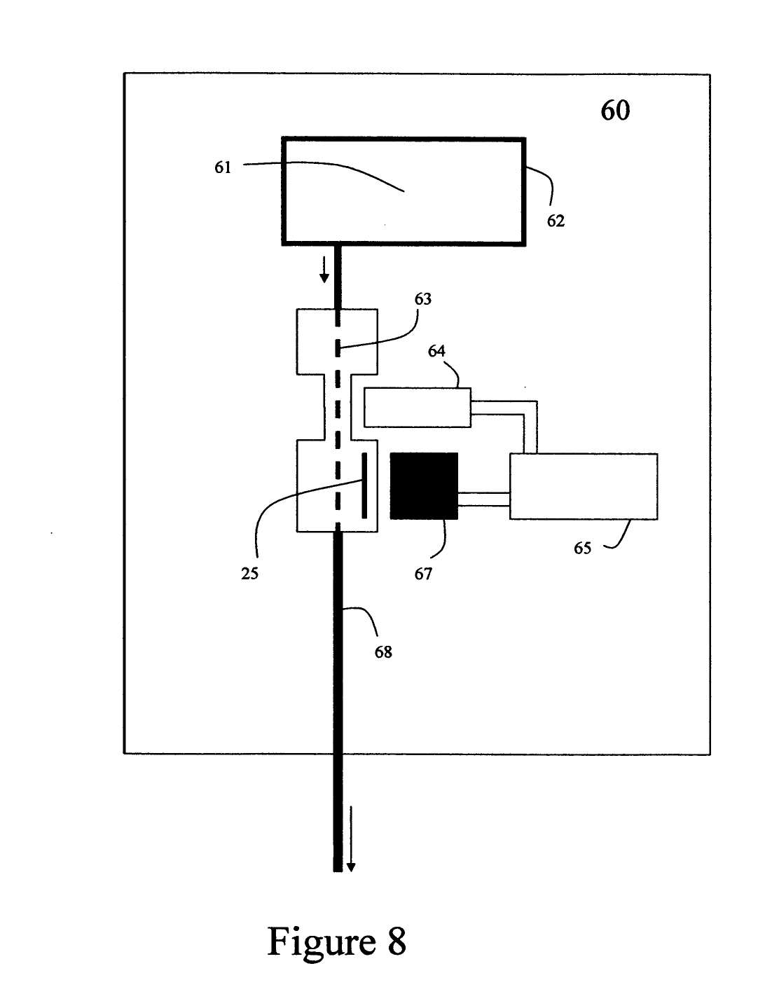

A manufacturing fixture 60 that may be used to measure T₁ is shown in FIG. 8. Standard fluid 61 is shown in pressurized container 62. Temperature T₀ is established for the standard fluid flowing through the flow channel being measured 63 and pressure P₀ is established for causing the standard fluid to flow through the flow channel 63. Flow channel 63 is temporarily mated with flow sensor 64 and standard fluid 61 caused to flow through channel 63 and finally to waste through waste pipe 68. When standard fluid 61 is flowing through flow channel 63, time of flight T₁ is measured. As is well known to those skilled in the art, a manufacturing fixture with many essentially identical flow sensors and the same number of mating sites for flow channels could be created such that T₁ for many flow channels could be measured at the same time. Processor 65 calculates Q₁ using T₁, Q₀, and T₀ and loads all four factors into memory 25 using memory writer 67. Factors Q₀ and T₀ may also be carried as part of the programming in flow regulator 13. As a practical matter, these measurements may be used for the purposes of quality control; rejecting flow channels where the measured time of flight and flow rate is outside established specification ranges. Memory 25 may also contain inventory information such as date of manufacture, expiration date, lot number, and other such quality control information as may be necessary. This information would also be written into memory 25 by memory writer 67.

When infusion set 12 with flow channel 24 is mated with flow regulator 13 as shown in FIG. 7, memory reader 26, which reads the information stored in memory 25, reads a time of flight and flow rate. As a practical matter, the acceptable specification ranges for flow rate would be set higher than any expected delivery rate for the infusion system.

We claim:

1. A system for supplying fluids at selected rates comprising
a conduit along which fluid flows, the conduit having an interrogation region with at least one predetermined geometrical or flow characteristic,
a pump adapted to move a nominal volume of fluid along the conduit with each pumping action,
a pump driver for causing the pump to perform pumping actions at nominal selected times, the nominal selected times corresponding to a user selectable fluid supply rate,
a sensor for measuring at least one property of flow of the fluid at the interrogation region,
a processor for calculating an actual supplied volume of fluid from each pumping action based on at least one property of fluid flow measured by the sensor and the geometric or flow property of the interrogation region, for calculating an actual supply rate based on the calculated actual supplied volume of fluid and the selected times, for comparing the actual supply rate and the selected supply rate, and for calculating new actuation times for the pump when the actual and selected supply rate are different such that the supply rate based on the new actuation times and actual supplied volume more nearly matches the selected supply rate.

2. The device of claim 1 wherein the sensor measures a thermal time of flight based on at least one thermal fluctuation injected into the fluid.

3. The device of claim 2 wherein the at least one injected thermal fluctuation is monitored based on changes in the index of refraction of the fluid inherent in the at least one thermal fluctuation.

4. The device of claim 2 wherein the at least one injected thermal fluctuation is monitored based on changes in the radiation of the fluid inherent in the at least one thermal fluctuation.

5. The device of claim 2 wherein the at least one injected thermal fluctuation is monitored based on changes in the resistivity of the fluid inherent in the at least one thermal fluctuation.

6. The device of claim 2 wherein the at least one injected thermal fluctuation is monitored based on changes in the temperature of the fluid inherent in the at least one thermal fluctuation.

7. The device of claim 3 wherein an optical monitoring system detects a change in light intensity based on one of reflection, refraction, diffraction, or interference of light due to an interaction of the light with the at least one injected thermal fluctuation.

8. The device of claim 1 wherein the sensor is capable of measuring at least one property of fluid flow at least 10 times per second.

9. The device of claim 8 wherein the sensor is capable of measuring at least one property of fluid flow at least 100 times per second.

10. The device of claim 1 wherein the system is comprised of a disposable component comprising a conduit and a stored geometrical or flow characteristic, and a reusable component comprising a sensor, a pump, a pump driver, a processor, and a reader of the stored characteristic.

11. The device of claim 11 wherein the sensor measures a thermal time of flight.

12. A method of supplying fluids at selected rates comprising the steps of
providing a conduit comprising an interrogation region and a memory containing information related to a geometric or flow property of the interrogation region,
providing a pump capable of moving fluid along the conduit in pumping actions such that a nominal volume of fluid is moved along the conduit with each pumping action,
providing a pump driver adapted to cause the pump to take pumping actions at selected times wherein nominal selected times correspond to nominal supply rates,
providing a sensor adapted to measure a property of fluid flow in the interrogation region, and
providing a processor for calculating an actual supplied volume of fluid from each pumping action based on the property of fluid flow measured by the sensor and the geometric property of the interrogation region, for calculating an actual supply rate based on the calculated actual supplied volume of fluid and the selected times, for comparing the actual supply rate and the selected supply rate, and for calculating new actuation times for the pump when the actual and selected supply rate are different such that the supply rate based on the new actuation times and actual supplied volume equals the selected supply rate.

13. A system for supplying fluid at selected rates comprising
a pump adapted to supply a nominal volume of fluid for each pumping action,
a pump driver adapted to cause the pump to take pumping actions at selected times to supply fluid at a selected supply rate,
a sensor adapted to measure the actual volume of fluid supplied by a pumping action, and
a processor for calculating an actual supply rate based on the actual volume and the selected times, for comparing the actual supply rate with the selected supply rate, and for calculating new pump actuation times when the actual supply rate is different than the selected supply rate such that the new actuation times and the actual volume provide a new supply rate equal to the selected supply rate.

14. A disposable fluid conduit comprising
an inlet and an outlet,
a flow cell further comprising an interrogation region at which a property of fluid flow may be measured,
registration points for mating of the fluid conduit to a sensor for measuring the property of fluid flow in the interrogation region, and
a memory wherein a geometrical of flow property of the interrogation region is stored.

15. A disposable fluid conduit comprising a flow cell, the flow cell further comprising an inlet, an outlet, an interrogation region at which a property of fluid flow may be measured, registration points for mating of the fluid conduit to a sensor for measuring the property of fluid flow in the flow cell, and a memory wherein a geometrical property of the interrogation region is stored.

16. A process for manufacturing a disposable fluid conduit comprising the steps of
manufacturing a flow cell having an inlet, an outlet, an interrogation region, and a memory,
measuring a geometrical or flow property of the interrogation region by flowing a known fluid through the interrogation region under known conditions, and
storing information related to the geometrical or flow property in the memory.

17. A system for supplying fluids at selected rates comprising
a conduit along which fluid flows, the conduit having an interrogation region with a predetermined geometrical or flow characteristic,
a pump adapted to move a variable volume of fluid along the conduit with each pumping action,
a pump driver for causing the pump to perform pumping actions at selected times, the selected times corresponding to selectable fluid supply rates,
a sensor for measuring a property of flow of the fluid at the interrogation region,
a processor for calculating an actual supplied volume of fluid from each pumping action based on the property of fluid flow measured by the sensor and the geometric property of the interrogation region, for calculating an actual supply rate based on the actual supplied volume of fluid and the selected times, for comparing the actual supply rate and the selected supply rate, and for calculating a new stroke volume for the pump when the actual and selected supply rate are different such that the supply rate based on the new stroke volume and the selected pump actuation times matches the selected supply rate.

18. The device of claim 17 wherein the sensor measures a thermal time of flight based on at least one thermal fluctuation injected into the fluid.

19. The device of claim 18 wherein the at least one injected thermal fluctuation is monitored based on changes in the index of refraction of the fluid inherent in the at least one thermal fluctuation.

20. The device of claim 18 wherein the at least one injected thermal fluctuation is monitored based on changes in the radiation of the fluid inherent in the at least one thermal fluctuation.

21. The device of claim 18 wherein the at least one injected thermal fluctuation is monitored based on changes in the resistivity of the fluid inherent in the at least one thermal fluctuations.

22. The device of claim 18 wherein the at least one injected thermal fluctuation is monitored based on changes in the temperature of the fluid inherent in the at least one thermal fluctuation.

23. The device of claim 19 wherein an optical monitoring system detects a change in light intensity based on reflection, refraction, diffraction, or interference of light due to an interaction of the light with the injected thermal fluctuation.

24. The device of claim 17 wherein the sensor is capable of measuring a property of fluid flow at least 10 times per second.

25. The device of claim 24 wherein the sensor is capable of measuring a property of fluid flow at least 100 times per second.

26. The device of claim 17 wherein the system is comprised of a disposable component comprising the conduit and a stored geometrical or flow characteristic, and a reusable component comprising the sensor, the pump, the pump driver, the processor, and a reader of the stored characteristic.

27. The device of claim 26 wherein the sensor measures a thermal time of flight.

28. A method of supplying fluids at selected rates comprising the steps of
providing a conduit comprising an interrogation region and a memory containing information related to a geometric or flow property of the interrogation region,
providing a pump and pump driver adapted to move fluid along the conduit at selected times in pumping actions of variable fluid volume,
providing electrical inputs to the pump from the pump driver such that the volume of fluid supplied during each pump stroke varies with the electrical inputs,
providing a sensor adapted to measure a property of fluid flow in the interrogation region, and
providing a processor for calculating an actual stroke volume of fluid from each pump stroke based on the property of fluid flow measured by the sensor and the geometric or flow property of the interrogation region, for calculating an actual supply rate based on the calculated stroke volume of fluid and the selected times, for comparing the actual supply rate and the selected supply rate, and for calculating new electrical inputs corresponding to a new pump stroke volume for the pump when the actual and selected supply rate are different such that the supply rate based on the selected actuation times and the new stroke volume matches the selected supply rate.
